(19) United States
(12) Patent Application Publication
(10) Pub. No.: US 2007/0179018 A1
(43) Pub. Date: Aug. 2, 2007

(54) Control device and control method of automatic transmission

(75) Inventors: Hiroatsu Endo, Nagoya-shi (JP); Kazuo Kawaguchi, Kasugai-shi (JP)

Correspondence Address: OLIFF & BERRIDGE, PLC, P.O. BOX 19928, ALEXANDRIA, VA, 22320, US

(73) Assignee: TOYOTA JIDOSHA KABUSHIKI KAISHA, TOYOTA-SHI (JP)

(21) Appl. No.: 11/653,412

(22) Filed: Jan. 16, 2007

(30) Foreign Application Priority Data
Jan. 31, 2006 (JP) 2006-021829

(51) Int. Cl. F16H 61/16

(52) U.S. Cl. 477/125

(57) ABSTRACT

There is a control device and a control method of an automatic transmission including; a plurality of friction engagement devices; a plurality of solenoids whose electrification amount supplied is controlled to adjust engagement force of the friction engagement devices, and which are switched between electrification and non-electrification so as to switch between speed change steps of the automatic transmission; and an abnormality determiner that performs abnormality determination regarding the solenoids based on predetermined condition. The solenoids operate when supplied with an electrification amount that exceeds a predetermined value. The abnormality determination is performed by supplying a solenoid put in a non-electrified state, of the solenoids, with as electrification amount that is less than or equal to the predetermined value.

### INCORPORATION BY REFERENCE

The disclosure of Japanese Patent Applications No. 2006-021829 filed on Jan. 31, 2006, including the specification, drawings and abstract, is incorporated herein by reference in its entirety.

### BACKGROUND OF THE INVENTION

1. Field of the Invention

The invention relates to a control device and a control method of an automatic transmission and, more particularly, to a technology that performs the abnormality determination regarding a plurality of solenoids that adjust the engagement forces of a plurality of friction engagement devices that are switched between engagement and release in order to achieve speed change steps.

2. Description of the Related Art

There is a known control device of an automatic transmission that includes a plurality of friction engagement devices for achieving speed change steps of the automatic transmission, and a plurality of solenoids whose electrification amount supplied is controlled to adjust the engagement forces of the friction engagement devices. For example, Japanese Patent Application Publication No. JP-A-2004-278713 describes a control device of an automatic transmission that includes a brake B1 and a brake B2 as friction engagement devices, and a solenoid SL1 and a solenoid SL2 that are provided for the brake B1 and the brake B2, respectively, for switching between the engagement and the release of the friction engagement devices.

In the automatic transmission described in Japanese Patent Application Publication No. JP-A-2004-278713, when a low speed step is to be achieved, both solenoids SL1 and SL2 are put into an electrified state to release the brake B1 and engage the brake B2. When a high speed step is to be achieved, both solenoids SL1 and SL2 are put into a non-electrified state to engage the brake B1 and release the brake B2.

In general, in the case where the presence/absence of an abnormality, such as a break, shortcircuit or the like of a solenoid as mentioned above, is to be determined, the abnormality is detected on the basis of a predetermined condition, for example, on the basis of a signal, such as a detection voltage that occurs when a current is passed through the solenoid; therefore, it is necessary that at least the solenoid be in the electrified state. Besides, from the viewpoint of accuracy improvement of the abnormality detection, higher frequencies of performing the abnormality determination are more desirable.

However, if the solenoid is in the non-excited state as in the case where the high speed step of the automatic transmission as described in the aforementioned Japanese Patent Application Publication, the abnormality determination cannot be performed particularly during the running of the vehicle on the high speed step. Therefore, a betterment that will heighten the frequency of abnormality determination is desired.

### SUMMARY OF THE INVENTION

A control device and a control method of an automatic transmission is provided as an embodiment as an example of the invention, which includes a plurality of friction engagement devices, a plurality of solenoids whose electrification amount supplied is controlled to adjust engagement force of the friction engagement devices, and an abnormality determination device that performs abnormality determination regarding the solenoids based on a predetermined condition, and which switches between speed change steps by switching between electrification and non-electrification of the solenoids, and in which the frequency of performing the abnormality determination regarding the solenoids is heightened and the abnormality detection accuracy is improved.

Accordingly, as an embodiment as an example of the invention, there is provided a control device of an automatic transmission that includes the following elements:
a plurality of friction engagement devices;
a plurality of solenoids whose electrification amount supplied is controlled to adjust engagement force of the friction engagement devices, and which are switched between electrification and non-electrification so as to switch between speed change steps of the automatic transmission; and
an abnormality determiner that performs abnormality determination regarding the solenoids based on predetermined condition,
   wherein the solenoids operate when supplied with an electrification amount that exceeds a predetermined value, and the abnormality determiner performs the abnormality determination by supplying a solenoid put in a non-electrified state, of the solenoids, with an electrification amount that is less than or equal to the predetermined value.

According to another aspect of the invention, in an automatic transmission that switches between speed change steps by switching between electrification and non-electrification of a plurality of solenoids whose electrification amount supplied is controlled to adjust engagement force of a plurality of friction engagement devices, there is provided a control method of the automatic transmission which control method performs abnormality determination regarding the solenoids. This control method includes:
operating the solenoids by supplying thereto an electrification amount that exceeds a predetermined value; and
performing the abnormality determination by supplying a solenoid put in a non-electrified state, of the solenoids, with an electrification amount that is less than or equal to the predetermined value.

According to the control device and the control method of the automatic transmission described above, the abnormality determination is performed by supplying a linear solenoid valve put in the non-electrified state,

of the plurality of linear solenoid valves that operate when supplied with drive current that exceeds the predetermined value, with an electrification amount that is less than or equal to the predetermined value, namely, such a degree of electrification amount that the linear solenoid valve does not operate. Therefore, the frequency of the abnormality determination regarding the linear solenoid valves is heightened and the abnormality detection accuracy improves, without affecting the shift control of the automatic transmission.

In a suitable construction, the aforementioned automatic transmission is constructed of any of various planetary gear type multi-step transmissions having speed change steps of, for example, forward four steps, forward five steps, forward six steps or more, in which one of a plurality of gear steps is selectively achieved as the rotating elements of a plurality of sets of planetary gear devices are selectively engaged, or a hybrid drive device has a configuration in which the automatic transmission includes a differential mechanism constructed of, for example, a planetary gear device, which distributes the motive power from an engine to a first electric motor and to an output shaft, and a second electric motor provided on the output shaft of the differential mechanism, and that mechanically transmits a major part of the motive power from the engine to the driving wheels and electrically transmits the remainder part of the motive power from the engine through the use of an electric path from the first electric motor to the second electric motor so that the speed change ratio is electrically altered, wherein the second electric motor is operatively linked to the output shaft via the above-described planetary gear type multi-step transmission, or the like.

Furthermore, in a suitable construction, the installed posture of the transmission relative to the vehicle may be a transversely mounted type in which the axis of the transmission is in the direction of width of the vehicle as in FF (front engine, front wheel drive) vehicles and the like, or a longitudinally mounted type in which the axis of the transmission is in the longitudinal direction of the vehicle as in FR (front engine, rear wheel drive) vehicles and the like.

In a suitable construction, as for the aforementioned friction engagement devices, hydraulic friction engagement devices that are engaged by hydraulic actuators, including a multi-plate type or single-plate clutches or brakes, belt-type brakes, etc., are widely used. The oil pump that supplies working oil for engaging the hydraulic type friction engagement devices may be, for example, a pump that is driven by a motive power source for running the vehicle to eject the working oil, or may also be a pump that is driven by a dedicated electric motor that is disposed separately from the vehicle-running motive power source. Besides, the clutches or brakes may also be electromagnetic engage devices, for example, electromagnetic clutches, magnetic particle clutches, etc., besides hydraulic type friction engagement devices.

Also, in a suitable construction, it is appropriate if the drive power source, such as the engine, that is, an internal combustion engine such as a gasoline engine, a diesel engine, etc., an electric motor, etc., and the automatic transmission are operatively interlinked. For example, a pulsation absorption damper (vibration damping device), a direct-couple clutch, a damper-equipped direct-couple clutch, a fluid transfer device, etc., may be disposed between therebetween. The drive power source and the input shaft of the automatic transmission may also be always linked. As for the fluid transfer device, a lockup clutch-equipped torque converter, a fluid coupling, etc., are widely used.

### BRIEF DESCRIPTION OF THE DRAWINGS

The features, advantages thereof, and technical and industrial significance of this invention will be better understood by reading the following detailed description of preferred embodiments of the invention, when considered in connection with the accompanying drawings, in which:

FIG. 1 is a diagram illustrating a hybrid drive device in accordance with an embodiment of the invention, and is a block diagram illustrating portions of a control system that is provided in the vehicle for controlling the hybrid drive device and the like;

FIG. 2 is an alignment chart showing a relative relationship in rotation speed among the rotating elements of a single-pinion type planetary gear device that functions as a torque combining-distributing mechanism;

FIG. 3 is an alignment chart representing an interrelationship among the rotating elements of a Ravigneaux type planetary gear mechanism that constitutes a transmission;

FIG. 4 shows a shift-purpose hydraulic control circuit for automatically controlling the shift of the transmission by engaging and releasing a first brake and a second brake;

FIG. 5 is a diagram showing a valve characteristic of a normally closed type first linear solenoid valve that establishes an open valve (communicated) state between the input port and the output port during a non-electrified state;

FIG. 6 is a diagram showing a valve characteristic of a normally open type second linear solenoid valve that establishes a closed valve (shut-off) state between the input port and the output port during the non-electrified state;

FIG. 7 is a table illustrating operations of a hydraulic control circuit;

FIG. 8 is a functional block diagram illustrating portions of control functions of electronic control devices shown in FIG. 1;

FIG. 9 is a shift chart that is used in a shift control of the transmission performed by the electronic control devices shown in FIG. 1; and

FIG. 10 is a flowchart illustrating portions of the control operations of the electronic control devices shown in FIG. 1, that is, a control operation for performing the abnormality determination when both the first linear solenoid valve and the second linear solenoid valve are in a non-excited state.

### DETAILED DESCRIPTION OF THE PREFERRED EMBODIMENTS

In the following description and the accompanying drawings, the present invention will be described in more detail with reference to exemplary embodiments.

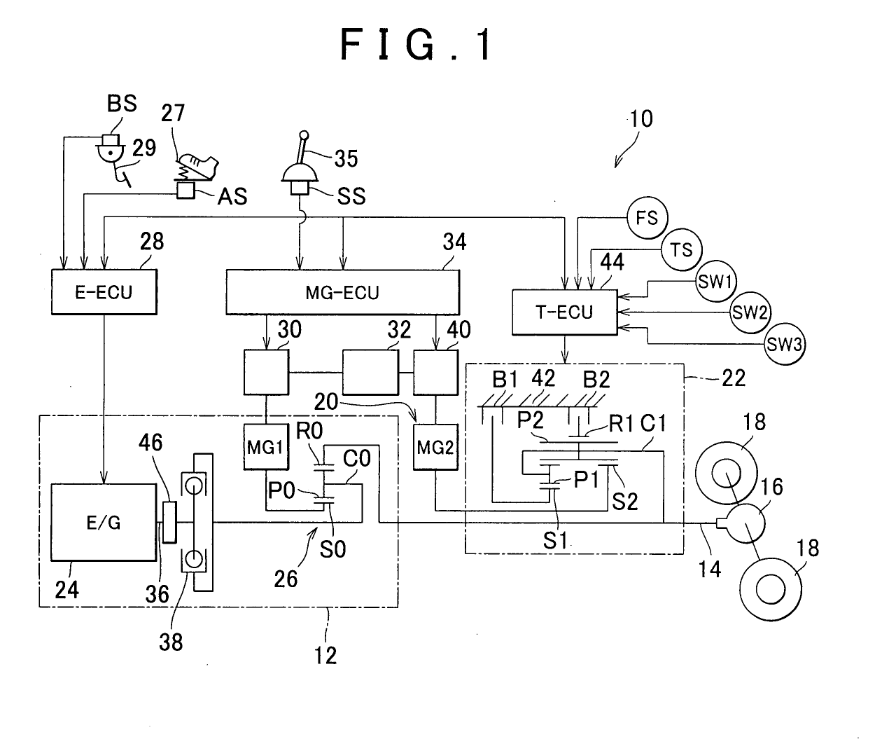

FIG. 1 is a diagram illustrating a hybrid drive device 10 in accordance with an embodiment of the invention. Referring to FIG. 1, in the hybrid drive device 10, torque of a first drive source 12 that is a main drive source is transmitted to an output shaft 14 that functions as an output member, and the torque is transmitted from the output shaft 14 to a pair of left and right driving wheels 18 via a differential gear device 16 in a vehicle. Besides, in the hybrid drive device 10, a second drive source 20 capable of selectively executing a power running control of outputting the drive power for running the vehicle or a regenerative control for recovering energy is provided. The second drive source 20 is linked to the output shaft 14 via a transmission 22. Therefore, the capacity of torque transmitted from the second drive source 20 to the output shaft 14 is increased or decreased in accordance with the speed change ratio γs (=the rotation speed of the MG2/the rotation speed of the output shaft 14) that is set by the transmission 22.

The transmission 22 is constructed so as to establish a plurality of steps whose speed change ratios γs is greater than or equal to “1”. Therefore, at the time of power running when torque is output from the second drive source 20, the torque can be increased by the transmission 22 while being transmitted to the output shaft 14. Hence, the second drive source 20 is constructed with a further reduced capacity or in a further reduced size. Due to this, for example, in the case where the rotation speed of the output shaft 14 increases in association with high vehicle speed, the speed change ratio γs is dropped to drop the rotation speed of the second drive source 20, in order to maintain a good state of the operation efficiency of the second drive source 20. In the case where the rotation speed of the output shaft 14 drops, the speed change ratio γs is increased.

As for the shifting of the transmission 22, the torque capacity of the transmission 22 drops or inertial torque associated with change in the rotation speed occurs, in which case the torque of the output shaft 14, that is, the output shaft torque, is affected. Therefore, in the hybrid drive device 10, on the occasion of shifting by the transmission 22, a control is performed such that the torque of the first drive source 12 is corrected so as to prevent or restrain the torque fluctuation of the output shaft 14.

The first drive source 12 is constructed mainly of an engine 24, a MG1 (hereinafter, referred to as “MG1”), and a planetary gear device 26 provided for combining or distributing torque between the engine 24 and the MG1. The engine 24 is a publicly known internal combustion engine that outputs power by burning fuel, such as a gasoline engine, a diesel engine, etc. The engine 24 is constructed so that states of operation thereof, such as a the throttle opening degree, the intake air amount, the fuel supply amount, the ignition timing, etc., are electrically controlled by an engine-controlling electronic control device (E-ECU) 28 that is made up mainly of a microcomputer. The electronic control device 28 is supplied with detection signals from an accelerator operation amount sensor AS that detects the operation amount of an accelerator pedal 27, a brake sensor BS for detecting operation of a brake pedal 29, etc.

The MG1 is, for example, a synchronous electric motor, and is constructed to selectively perform the function as an electric motor of generating drive torque and the function as an electric power generator. The MG1 is connected to an electricity storage device 32, such as a battery, a capacitor, etc., via an inverter 30. Then, the inverter 30 is controlled by a motor-generator-controlling electronic control device (MG-ECU) 34 made up mainly of a microcomputer so that the output torque of the MG1 or the regenerative torque is adjusted or set. The electronic control device 34 is supplied with detection signals from an operation position sensor SS that detects the operation position of a shift lever 35, and the like.

The planetary gear device 26 is a single-pinion type planetary gear mechanism that includes three rotating elements: a sun gear S0, a ring gear R0 disposed concentrically with the sun gear S0, and a carrier C0 that supports pinions P0 meshing with the sun gear S0 and the ring gear R0, in such a manner that the pinions P0 are rotatable about their own axes and also revolvable. The planetary gear device 26 causes known differential effect. The planetary gear device 26 is provided concentrically with the engine 24 and the transmission 22. Since the planetary gear device 26 and the transmission 22 are constructed substantially symmetrically about a center line, the half portions thereof below the center line are omitted in FIG. 1.

In this embodiment, a crankshaft 36 of the engine 24 is linked to the carrier C0 of the planetary gear device 26 via a damper 38. The sun gear S0 is linked to the MG1, and the output shaft 14 is linked to the ring gear R0. The carrier C0 functions as an input element, and the sun gear S0 functions as a reaction force element, and the ring gear R0 functions as an output element.

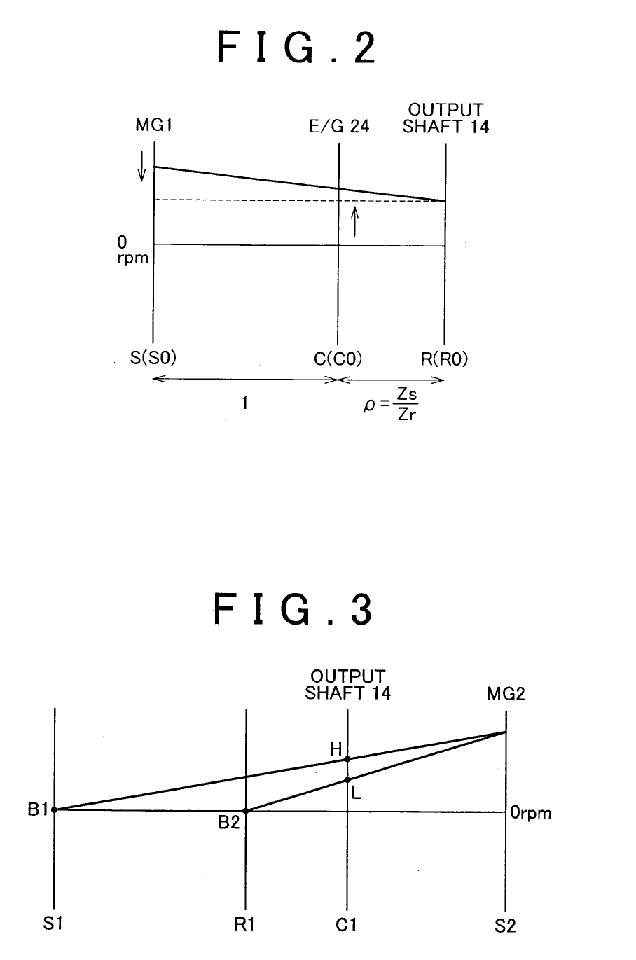

Relative relationships among the rotating elements of the single-pinion type planetary gear device 26 that functions as a torque combining-distributing mechanism are shown by an alignment chart in FIG. 2. In the alignment chart, a vertical axis S, a vertical axis C, and a vertical axis R represent the rotation speed of the sun gear S0, the rotation speed of the carrier C0, and the rotation speed of the ring gear R0, respectively. The intervals between the vertical axis S, the vertical axis C, and the vertical axis R are set so that when the interval between the vertical axis S and the vertical axis C is 1, the interval between the vertical axis C and the vertical axis R becomes ρ (the number of teeth Zs of the sun gear S0/the number of teeth Zr of the ring gear R0).

In the planetary gear device 26, when a reaction torque from the MG1 is input to the sun gear S0 while the output torque of engine 24 is input to the carrier C0, a torque greater than the torque input from the engine 24 appears on the ring gear R0 that is the output element, so that the MG1 functions as an electric power generator. While the rotation speed of the ring gear R0 (output shaft rotation speed) NO is constant, the rotation speed NE of the engine 24 can be continuously (steplessly) changed by changing the rotation speed of the MG1 upward or downward. The dashed line in FIG. 2 shows a state where the rotation speed NE of the engine 24 drops when the rotation speed of the MG1 is lowered from the value shown by a solid line. That is, a control of setting the rotation speed NE of the engine 24 at, for example, a rotation speed that provides the best fuel economy, can be executed by controlling the MG1. This type of hybrid system is termed mechanical distribution system or split type.

Referring back to FIG. 1, the transmission 22 of the embodiment is constructed of one set of a Ravigneaux type planetary gear mechanism. Specifically, in the transmission 22, a first sun gear S1 and a second sun gear S2 are provided, and short pinions P1 mesh with the first sun gear S1. The short pinions P1 also mesh with long pinions P2 whose axial length is longer than that of the short pinions P1. The long pinions P2 mesh with a ring gear R1 that is disposed concentrically with the sun gears S1, S2. The pinions P1, P2 are supported by a common carrier C1 so as to be rotatable about their own axes and also revolvable. Besides, the second sun gear S2 meshes with the long pinions P2.

The second drive source 20 is constructed of a second motor-generator (hereinafter, referred to as “MG2”) that is an electric motor or an electric power generator that is controlled by the motor-generator-controlling electronic control device (MG-ECU) 34 via an inverter 40 so that the assist-purpose output torque or the regenerative torque is adjusted or set. The MG2 is linked to the second sun gear S2, and the carrier C1 is linked to the output shaft 14. The first sun gear S1 and the ring gear R1, together with the pinions P1, P2, construct a mechanism that corresponds to a double-pinion type planetary gear device. The second sun gear S2 and the ring gear R1, together with the long pinions P2, construct a mechanism that corresponds to a single-pinion type planetary gear device.

The transmission 22 is also provided with a first brake B1 that is provided between the first sun gear S1 and a transmission housing 42 for selectively fixing the first sun gear S1, and a second brake B2 that is provided between the ring gear R1 and the transmission housing 42 for selectively fixing the ring gear R1. These brakes B1, B2 are so-called friction engagement devices that produce braking force by friction force. As the brakes, it is possible to adopt multi-plate type engagement devices or band-type engagement devices. Then, each of the brakes B1, B2 is constructed so that the torque capacity thereof continuously changes in accordance with the engagement pressure that is generated by a hydraulic actuator or the like.

In the transmission 22 constructed as described above, when the second sun gear S2 functions as an input element and the carrier C1 functions as an output element and the first brake B1 is engaged, a high speed step H whose speed change ratio γsh is greater than “1” is achieved. If the second brake B2 is engaged instead of the first brake B1 in a similar situation, a low speed step L whose speed change ratio γsl is greater than the speed change ratio γsh of the high speed step H is set. The shifting between the speed change steps H and L is executed on the basis of states of run of the vehicle such as the vehicle speed, the required drive power (or the accelerator operation amount), etc. More concretely, speed change step regions are determined beforehand as a map (shift chart), and a control is performed such as to set either one of the speed change steps in accordance with the detected vehicle driving state. A shift-controlling electronic control device (T-ECU) 44 made up mainly of a microcomputer for performing the control is provided.

The electronic control device 44 is supplied with detection signals from an oil temperature sensor TS for detecting the temperature of the working oil, a hydraulic switch SW1 for detecting the engagement oil pressure of the first brake B1, a hydraulic switch SW2 for detecting the engagement oil pressure of the second brake B2, a hydraulic switch SW3 for detecting the line pressure PL, etc.

FIG. 3 shows an alignment chart that has four vertical axes, that is, a vertical axis S1, a vertical axis R1, a vertical axis C1, and a vertical axis S2, in order to represent relative relationships between the rotating elements of the Ravigneaux type planetary gear mechanism that constitutes the transmission 22. The vertical axis S1, the vertical axis R1, the vertical axis C1, and the vertical axis S2 show the rotation speed of the first sun gear S1, the rotation speed of the ring gear R1, the rotation speed of the carrier C1, and the rotation speed of the second sun gear S2, respectively.

In the transmission 22 constructed as described above, when the ring gear R1 is fixed by the second brake B2, the low speed step L is set, and the assist torque that the MG2 outputs is amplified in accordance with the corresponding speed change ratio γsl, and is thus applied to the output shaft 14. On the other hand, when the first sun gear S1 is fixed by the first brake B1, the high speed step H having the speed change ratio γsh that is smaller than the speed change ratio γhl of the low speed step L is set. Since the speed change ratio of the high speed step H is also larger than “1”, the assist torque that the MG2 outputs is amplified in accordance with the speed change ratio γsh, and is applied to the output shaft 14.

Incidentally, although the torque applied to the output shaft 14 during a state where one of the speed change steps L, H is steadily set is a torque obtained by increasing the output torque of the MG2 in accordance with the corresponding speed change ratio, the torque during a shift transitional state of the transmission 22 is a torque that is affected by the torque capacity at the brake B1 or B2, the inertia torque associated with the rotation speed change, etc. Besides, the torque applied to the output shaft 14 becomes positive torque during a driving state of the MG2, and becomes negative torque during a driven state of the MG2.

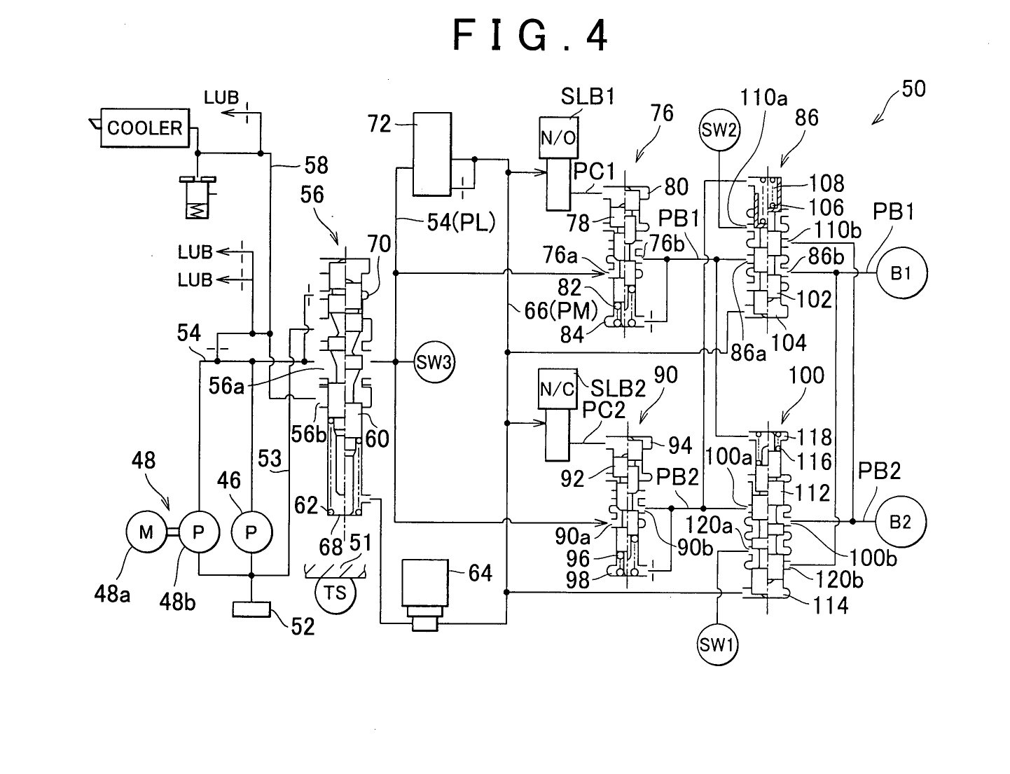

FIG. 4 shows a shift-purpose hydraulic control circuit 50 for automatically controlling the shifting of the transmission 22 by engaging and releasing the brakes B1, B2. The hydraulic control circuit 50 includes, as oil pressure sources, a mechanical type hydraulic pump 46 that is operatively linked to the crankshaft 36 of the engine 24 and therefore is rotationally driven by the engine 24, and an electric type hydraulic pump 48 that includes an electric motor 48a and a pump 48b that is rotationally driven by the electric motor 48a. The mechanical type hydraulic pump 46 and the electric type hydraulic pump 48 suck the working oil that is refluxed to an oil pan (not shown), via a strainer 52, or suck the working oil that is directly refluxed via a reflux oil passageway 53, and pumps the working oil to a line pressure oil passageway 54. An oil temperature sensor TS for detecting the oil temperature of the refluxed working oil is provided on a valve body 51 that partially forms the hydraulic control circuit 50, but may also be connected to a different site.

A line pressure regulating valve 56 is a relief-type pressure regulating valve, and includes a spool valve element 60 that opens and closes between a supply port 56a connected to the line pressure oil passageway 54 and a discharge port 56b connected to a drain oil passageway 58, a control oil chamber 68 which houses a spring 62 that generates thrust in the closing direction of the spool valve element 60 and which receives a module pressure PM from a module pressure oil passageway 66 via an electromagnetic open-close valve 64 when the set pressure of the line pressure PL is altered to a higher level, and a feedback oil chamber 70 connected to the line pressure oil passageway 54 which generates thrust in the opening direction of the spool valve element 60. The line pressure regulating valve 56 outputs a constant line pressure PL that is one of a low pressure and a high pressure. The line pressure oil passageway 54 is provided with a hydraulic switch SW3 that is in an off-state when the line pressure PL is at the high pressure-side value, and that is in an on-state when the line pressure PL is at the low pressure-side value or lower.

A module pressure regulating valve 72 outputs to the module pressure oil passageway 66 a constant module pressure PM that is set lower than the low pressure-side line pressure PL, using the line pressure PL as a basic pressure, regardless of fluctuations of the line pressure PL. A first linear solenoid valve SLB1 for controlling the first brake B1 and a second linear solenoid valve SLB2 for controlling the second brake B2, using the module pressure PM as a basic pressure, output control pressures PC1 and PC2 in accordance with drive currents (i.e., the amounts of electrification) ISOL1 and ISOL2 that are command values from the electronic control device 44.

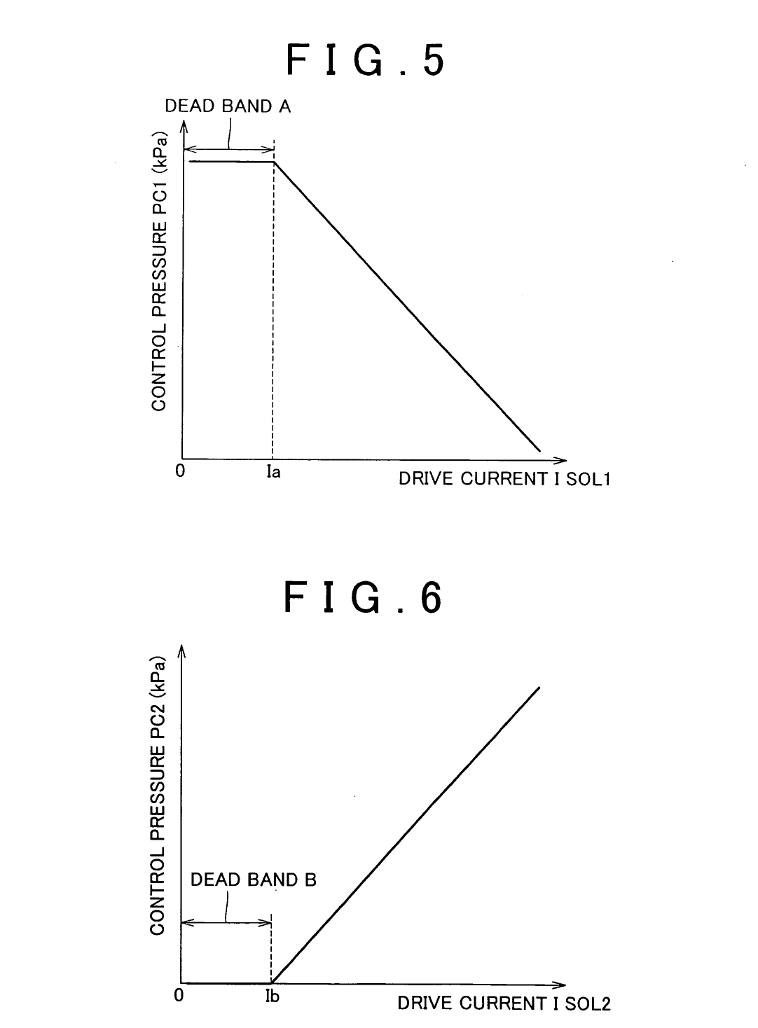

The first linear solenoid valve SLB1 has a normally open type valve characteristic of establishing an open valve (communicated) state between the input port and the output port during the non-electrified state. As shown in FIG. 5, as the drive current ISOL1 increases, the output control pressure PC1 is dropped. As shown in FIG. 5, the first linear solenoid valve SLB1 operates so that the control pressure PC1 is dropped, when the first linear solenoid valve SLB1 is supplied with the drive current ISOL1 exceeding a predetermined value Ia. The first linear solenoid valve SLB1 has a dead band A in which the first linear solenoid valve SLB1 does not operate when the drive current ISOL1 is lower than or equal to the predetermined value Ia. That is, the valve characteristic of the first linear solenoid valve SLB1 is provided with the dead band A in which the output control pressure PC1 does not drop until the drive current ISOL1 exceeds the predetermined value Ia.

The second linear solenoid valve SLB2, contrary to the first linear solenoid valve SLB1, has a normally closed type valve characteristic of establishing a closed (shut-off) state between the input port and the output port during the non-electrified state. As shown in FIG. 6, as the drive current ISOL2 increases, the output control pressure PC2 is increased. As shown in FIG. 6, the second linear solenoid valve SLB2 operates so that the control pressure PC2 is increased, when the second linear solenoid valve SLB2 is supplied with the drive current ISOL2 exceeding a predetermined value Ib. The second linear solenoid valve SLB2 has a dead band B in which the second linear solenoid valve SLB2 does not operate when the drive current ISOL2 is lower than or equal to the predetermined value Ib. That is, the valve characteristic of the second linear solenoid valve SLB2 is provided with the dead band B in which the output control pressure PC2 does not increase until the drive current ISOL2 exceeds the predetermined value Ib.

A B1 control valve 76 includes a spool valve element 78 that opens and closes between an input port 76a connected to the line pressure oil passageway 54 and an output port 76b that outputs a B1 engagement oil pressure PB1, a control oil chamber 80 that receives the control pressure PC1 from the first linear solenoid valve SLB1 in order to urge the spool valve element 78 in the opening direction, and a feedback oil chamber 84 which houses a spring 82 that urges the spool valve element 78 in the closing direction and which receives the B1 engagement oil pressure PB1 that is the output pressure. The B1 control valve 76, using the line pressure PL in the line pressure oil passageway 54 as a basic pressure, outputs the B1 engagement oil pressure PB1 whose magnitude is in accordance with the control pressure PC1 from the first linear solenoid valve SLB1, and supplies it to the brake B1 through a B1 apply control valve 86 that functions as an interlock valve.

A B2 control valve 90 includes a spool valve element 92 that opens and closes between an input port 90a connected to the line pressure oil passageway 54 and an output port 90b that outputs a B2 engagement oil pressure PB2, a control oil chamber 94 that receives the control pressure PC2 from the second linear solenoid valve SLB2 in order to urge the spool valve element 92 in the opening direction, and a feedback oil chamber 98 which houses a spring 96 that urges the spool valve element 92 in the closing direction and which receives the B2 engagement oil pressure PB2 that is the output pressure. The B2 control valve 90, using the line pressure PL in the line pressure oil passageway 54 as a basic pressure, outputs the B2 engagement oil pressure PB2 whose magnitude is in accordance with the control pressure PC2 from the second linear solenoid valve SLB2, and supplies it to the brake B2 through a B2 apply control valve 100 that functions as an interlock valve.

The B1 apply control valve 86 includes a spool valve element 102 which opens and closes an input port 86a that receives the B1 engagement oil pressure PB1 output from the B1 control valve 76 and an output port 86b connected to the first brake B1, an oil chamber 104 that receives the module pressure PM in order to urge the spool valve element 102 in the opening direction, and an oil chamber 108 which houses a spring 106 that urges the spool valve element 102 in the closing direction and which receives the B2 engagement oil pressure PB2 output from the B2 control valve 90. The B1 apply control valve 86 is held in the open valve state until it is supplied with the B2 engagement oil pressure PB2 for engaging the second brake B2. When the B2 engagement oil pressure PB2 is supplied, the B1 apply control valve 86 is switched to the closed valve state, so that the engagement of the first brake B1 is prevented.

The B1 apply control valve 86 is provided with a pair of ports 110a and 110b that are closed when the spool valve element 102 is in the open valve position (position as indicated on the right side of a center line shown in FIG. 4), and that are opened when the spool valve element 102 is in the valve closed position (position as indicated on the left side of the center line shown in FIG. 4). The hydraulic switch SW2 for detecting the B2 engagement oil pressure PB2 is connected to the port 110a, and the second brake B2 is directly connected to the other port 110b. The hydraulic switch SW2 assumes an on-state when the B2 engagement oil pressure PB2 becomes a high-pressure state that is set beforehand, and is switched to an off-state when the B2 engagement oil pressure PB2 reaches or goes below a low-pressure state that is set beforehand. Since the hydraulic switch SW2 is connected to the second brake B2 via the B1 apply control valve 86, it is possible to determine the presence/absence of an abnormality of the first linear solenoid valve SLB1, the B1 control valve 76, the B1 apply control valve 86, etc., that constitute the hydraulic system of the first brake B1, as well as the presence/absence of an abnormality of the B2 engagement oil pressure PB2.

The B2 apply control valve 100, similar to the B1 apply control valve 86, includes a spool valve element 112 that opens and closes between an input port 100a that receives the B2 engagement oil pressure PB2 output from the B2 control valve 90 and an output port 100b connected to the second brake B2, an oil chamber 114 that receives the module pressure PM in order to urge the spool valve element 112 in the opening direction, and an oil chamber 118 which houses a spring 116 that urges the spool valve element 112 in the closing direction and which receives the B1 engagement oil pressure PB1 output from the B1 control valve 76. The B2 apply control valve 100 is held in the open valve state until it is supplied with the B1 engagement oil pressure PB1 for engaging the first brake B1. When the B1 engagement oil pressure PB1 is supplied, the B2 apply control valve 100 is switched to the closed valve state, so that the engagement of the second brake B2 is prevented.

The B2 apply control valve 100 is also provided with a pair of parts 120a and 120b that are closed when the spool valve element 112 is in the open valve position (position as indicated on the right side of a center line shown in FIG. 4), and that are opened when the spool valve element 112 is in the valve closed position (position as indicated on the left side of the center line shown in FIG. 4). The hydraulic switch SW1 for detecting the B1 engagement oil pressure PB1 is connected to the port 120a, and the first brake B1 is directly connected to the other port 120b. The hydraulic switch SW1 assumes an on-state when the B1 engagement oil pressure PB1 becomes a high-pressure state that is set beforehand, and is switched to an off-state when the B1 engagement oil pressure PB1 reaches or goes below a low-pressure state that is set beforehand. Since the hydraulic switch SW1 is connected to the first brake B1 via the B2 apply control valve 100, it is possible to determine the presence/absence of an abnormality of the second linear solenoid valve SLB2, the B2 control valve 90, the B2 apply control valve 100, etc., that constitute the hydraulic system of the second brake B2, as well as the presence/absence of an abnormality of the B1 engagement oil pressure PB1.

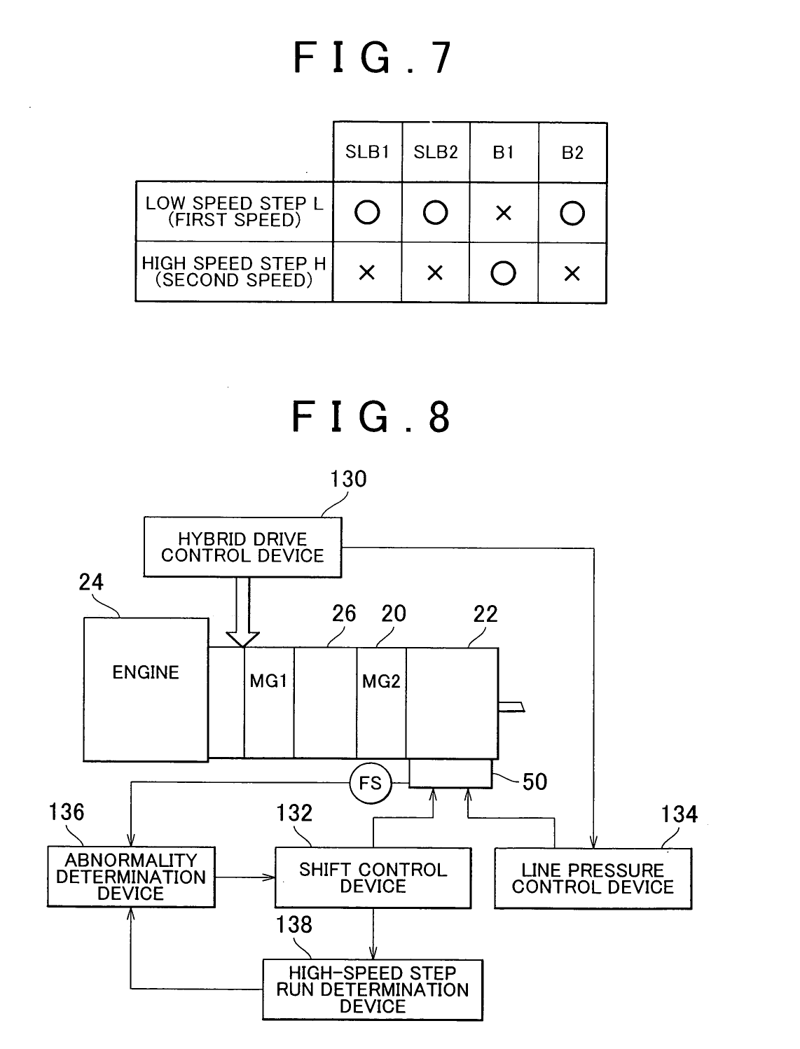

FIG. 7 is a table illustrating operations of the hydraulic control circuit 50 constructed as described above. In FIG. 7, symbol “◯” shows the excited state or the engaged state, and symbol “×” shows the non-excited state or the released state. That is, by putting both the first linear solenoid valve SLB1 and the second linear solenoid valve SLB2 into the excited state, that is, the electrified state, the first brake B1 is put into the released state and the second brake B2 is put into the engaged state, so that the low speed step L (i.e., the first speed gear step) of the transmission 22 is achieved. By putting both the first linear solenoid valve SLB1 and the second linear solenoid valve SLB2 into the non-excited state, that is, the non-electrified state, the first brake B1 is put into the engaged state and the second brake B2 is put into the released state, so that the high speed step H (i.e., the second speed gear step) of the transmission 22 is achieved.

Thus, in the transmission 22, the first linear solenoid valve SLB1 and the second linear solenoid valve SLB2 are opposite in operation, that is, have opposite valve characteristics, that is, the normally open type and the normally closed type. From a different viewpoint, the first linear solenoid valve SLB1, contrary to the second linear solenoid valve SLB2, is switched in the valve state to a position for completely engaging the first brake B1 when put into the non-excited state. Therefore, as the first linear solenoid valve SLB1 and the second linear solenoid valve SLB2 are both put into the non-excited state, the high speed step H is achieved.

FIG. 8 is a functional block diagram illustrating portions of control functions of the electronic control devices 28, 34 and 44. In FIG. 8, for example, when the control is activated as the power switch is operated during a state where the brake pedal is operated after the key has been inserted into the key slot, a hybrid drive control device 130 calculates a driver's requested output on the basis of the accelerator operation amount, and causes the engine 24 and/or the MG2 to generate the requested output so as to bring about an operation with good fuel economy and low emission gas amount. For example, the run mode is switched in accordance with the state of run of the vehicle, among a motor run mode in which the engine 24 is stopped and the MG2 is solely used as drive source, a run mode in which the vehicle is run by using the MG2 as a drive source while electric power is generated from the motive power of the engine 24, and an engine run mode in which the vehicle is run by mechanically transmitting the motive power of the engine 24 to the driving wheels 18.

The hybrid drive control device 130 controls the rotation speed of the engine 24 via the MG1 so that the engine 24 operates on an optimal fuel economy curve, even when the engine 24 is driven. Besides, in the case where the MG2 is driven to perform the torque assist, the hybrid control device 130 sets the transmission 22 to the low speed step L to increase the torque applied to the output shaft 14 during a state of low vehicle speed. During a state of increased vehicle speed, the hybrid control device 130 sets the transmission 22 to the high speed step H to relatively drop the rotation speed of the MG2 and therefore reduce the loss. Thus, the torque assist with good efficiency is executed. Furthermore, during the coasting run, the inertia energy that the vehicle has is used to rotationally drive the MG1 or the MG2, so that the energy is regenerated as electric power that is in turn stored into the electricity storage device 32.

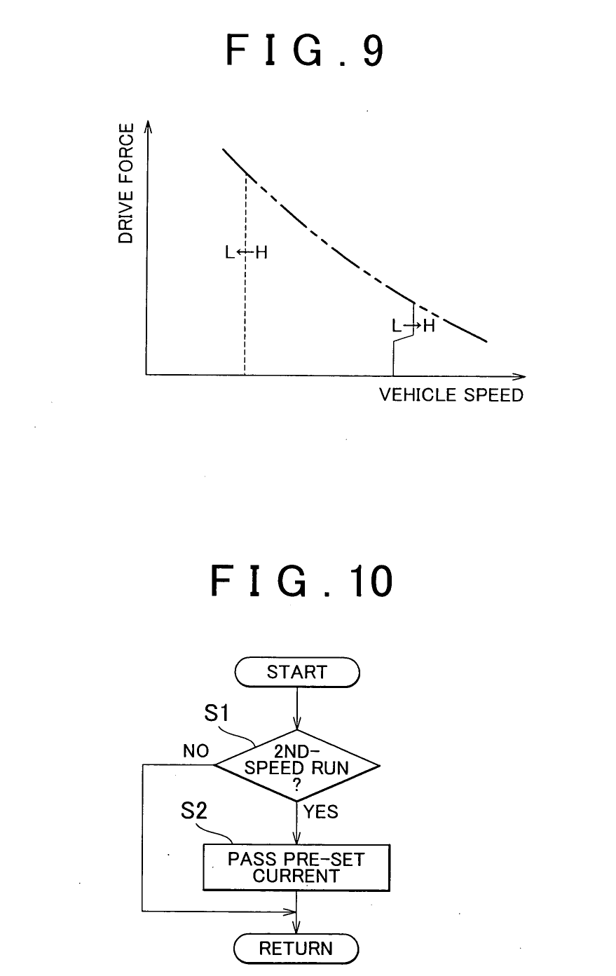

A shift control device 132 determines a speed change step of the transmission 22 on the basis of the speed V and the drive power P of the vehicle from a pre-stored shift chart, for example, as shown in FIG. 9, and outputs the drive currents ISOL1 and ISOL2, i.e., the command values, to the hydraulic control circuit 50 to control the engagement and release of the first brake B1 and the second brake B2 so that the switch to the determined speed change step is automatically performed.

In the case where the calculated driver's requested output is greater than a pre-set output criterion value, or in the case where the transmission 22 is performing a shift, that is, is in a shift transition state, or the like, a line pressure control device 134 switches the set pressure of the line pressure PL from a low pressure state to a high pressure state by switching the electromagnetic open-close valve 64 from the closed state to the open state to supply the module pressure PM into the oil chamber 68 of the line pressure regulating valve 56 and to therefore increase the thrust on the spool valve element 60 in the closing direction by a predetermined value.

An abnormality determination device 136 determines the presence/absence of an abnormality of the first linear solenoid valve SLB1 and the second linear solenoid valve SLB2, such as a break, shortcircuit, etc.

The abnormality determination device 136 determines the presence/absence of an abnormality, such as a break, shortcircuit, etc., regarding each of the first linear solenoid valve SLB1 and the second linear solenoid valve SLB2, for example, on the basis of a detection signal supplied to the electronic control device 44 from a well-known IC type abnormality detection sensor FS, such as a break detection sensor, a shortcircuit detection sensor, etc. That is, the sensor passes the drive current ISOL for the linear solenoid valve through a current detection-purpose resistance, and compares the value of the voltage fall across the resistance with the value of a reference voltage through the use of an operational amplifier. If the voltage fall across the current detection-purpose resistance is outside a predetermined range with respect to the reference voltage level, the sensor outputs an abnormality detection signal.

Thus, in order to perform the abnormality determination regarding the first linear solenoid valve SLB1 and the second linear solenoid valve SLB2, it is necessary that the first linear solenoid valve SLB1 and the second linear solenoid valve SLB2 be respectively in the electrified state. In such circumstances, the abnormality determination cannot be performed regarding the high speed step H of the transmission 22 of this embodiment since the high speed step H is achieved by putting both the first linear solenoid valve SLB1 and the second linear solenoid valve SLB2 into the non-excited state. From the viewpoint of accuracy improvement of the abnormality detection, higher frequencies of performing the abnormality determination are more desirable; hence, a betterment that will heighten the frequency is desired. Besides, in the case where a fail-safe operation is performed when an abnormality is detected, there is a possibility that the fail-safe operation cannot be performed if the abnormality determination cannot be performed.

In order to heighten the frequency of the abnormality determination regarding the linear solenoid valve and therefore improve the abnormality detection accuracy, the abnormality determination device 136 supplies a linear solenoid valve put in the non-electrified state, of the first linear solenoid valve SLB1 and the second linear solenoid valve SLB2, with a predetermined current of such a degree that the linear solenoid valve does not operate, that is, an abnormality detection-purpose drive current IkSOL (drive current IkSOL1, IkSOL2) that is a drive current ISOL (drive current ISOL1, ISOL2) that is less than or equal to a predetermined value I (predetermined value Ia, Ib). In this manner, the abnormality determination device 136 performs the abnormality determination without affecting the shift control of the transmission 22.

For example, while the vehicle is running on the high speed step H that is achieved by putting both the first linear solenoid valve SLB1 and the second linear solenoid valve SLB2 into the non-excited state, the abnormality determination device 136 outputs to the shift control device 132 a command to supply the first linear solenoid valve SLB1 with the abnormality detection-purpose drive current IkSOL1 that is the drive current ISOL1 that is less than or equal to the predetermined value Ia and to supply the second linear solenoid valve SLB2 with the abnormality detection-purpose drive current IkSOL2 that is the drive current ISOL2 that is less than or equal to the predetermined value Ib. On the basis of the detection signal from the abnormality detection sensor FS, the abnormality determination device 136 determines the presence/absence of an abnormality, such as a break, shortcircuit, or the like, regarding each of the first linear solenoid valve SLB1 and the second linear solenoid valve SLB2. In this manner, the abnormality determinations regarding the first linear solenoid valve SLB1 and the second linear solenoid valve SLB2 are performed all together without affecting the shift control of the transmission 22.

A high-speed step run determination device 138 determines whether or not the vehicle is running on the high speed step H of the transmission 22, for example, on the basis of whether or not the present state is a state where the drive currents ISOL1 and ISOL2 that are command values to the hydraulic control circuit 50 have not been output by the shift control device 132 in order to set the high speed step H while the vehicle is running.

FIG. 10 is a flowchart illustrating portions of the control functions of the electronic control devices 28, 34 and 44, that is, a control operation for performing the abnormality determination when both the first linear solenoid valve SLB1 and the second linear solenoid valve SLB2 are the non-excited state. This control operation is repeatedly executed in a very short cycle time of, for example, about several msec to several ten msec.

Firstly, in step (hereinafter, “step” will be omitted) S1 corresponding to the high-speed step run determination device 138, it is determined whether or not the vehicle is running on the high speed step H (i.e., the second speed gear step) of the transmission 22, for example, on the basis of whether or not the present state is the state where the drive currents ISOL1 and ISOL2 have not been output to the hydraulic control circuit 50 in order to set the high speed step H while the vehicle is running.

If a negative judgment is made in S1, this routine is ended. If an affirmative judgment is made in S1, the process proceeds to S2 corresponding to the abnormality determination device 136. In S2, the command to supply the first linear solenoid valve SLB1 with the abnormality detection-purpose drive current IkSOL1 and supply the second linear solenoid valve SLB2 with the abnormality detection-purpose drive current IkSOL2 is output. On the basis of the detection signal from the abnormality detection sensor FS, the presence/absence of an abnormality, such as a break, shortcircuit, etc., is determined regarding each of the first linear solenoid valve SLB1 and the second linear solenoid valve SLB2.

As described above, according to the embodiment, the abnormality determination is performed by supplying a linear solenoid valve put in the non-electrified state, of the linear solenoid valves (linear solenoid valves SLB1, SLB2) that operate when supplied with the drive current ISOL (drive currents ISOL1, ISOL2) that exceeds the predetermined value I (predetermined values Ia, Ib), with the drive current ISOL that is less than or equal to the predetermined value I, namely, such a degree of drive current ISOL that the linear solenoid valve does not operate, by the abnormality determination device 136. Therefore, the frequency of the abnormality determination regarding the linear solenoid valves is heightened and the abnormality detection accuracy improves, without affecting the shift control of the transmission 22.

Furthermore, according to the embodiment, since each of the linear solenoid valves has a dead band (A, B as seen in FIGS. 5 and 6) in which the linear solenoid valve does not operate when the drive current ISOL is less than or equal to the predetermined value I (predetermined values Ia, Ib), the abnormality determination regarding the linear solenoid valves is performed by the abnormality determination device 136 without affecting the shift control of the transmission 22.

Furthermore, according to the embodiment, the abnormality determination is performed by the abnormality determination device 136 while the vehicle is running on the high speed step H that is achieved by putting both the first linear solenoid valve SLB1 and the second linear solenoid valve SLB2 into the non-excited state, the abnormality determinations regarding the first linear solenoid valve SLB1 and the second linear solenoid valve SLB2 are performed all together without affecting the shift control of the transmission 22.

Furthermore, according to the embodiment, since the first linear solenoid valve SLB1, contrary to the second linear solenoid valve SLB2, is switched in the valve state to the position for completely engaging the first brake B1 when put into the non-excited state, the high speed step H is achieved when both the first linear solenoid valve SLB1 and the second linear solenoid valve SLB2 are put in the non-excited state.

While the embodiment of the invention has been described in detail with reference to the drawings, the invention is also applicable in other manners.

For example, in the foregoing embodiment, the abnormality determination device 136 determines the presence/absence of an abnormality, such as a break, shortcircuit, etc., regarding each of the first linear solenoid valve SLB1 and the second linear solenoid valve SLB2 while the vehicle is running on the high speed step H that is achieved by putting both the first linear solenoid valve SLB1 and the second linear solenoid valve SLB2 into the non-excited state. However, the abnormality determination may be performed not only during the running on the high speed step H but also during other states of the vehicle. For example, the abnormality determination may also be performed during a stop of the vehicle or the like, by actively putting both or one of the first linear solenoid valve SLB1 and the second linear solenoid valve SLB2 into the non-excited state.

Furthermore, in the foregoing embodiment, in the transmission 22 in which a speed change step is achieved by putting both the first linear solenoid valve SLB1 and the second linear solenoid valve SLB2 into the non-excited state, the abnormality determination regarding that speed change step is performed by the abnormality determination device 136. However, this transmission 22 is not restrictive, but the invention is also applicable to other types of transmissions. For example, if a transmission has three linear solenoid valves instead of two linear solenoid valves, the invention is also applicable to the transmission. Furthermore, the invention is also applicable to an automatic transmission in which a speed change step is achieved by putting at least one linear solenoid valve into the non-excited state. In any transmission, there is no need to perform the abnormality determination regarding every linear solenoid valve, but it is allowable that the abnormality determination be performed regarding at least one of the linear solenoid valves put into the non-excited state.

Furthermore, although in the foregoing embodiment, the abnormality determination device 136 determines the presence/absence of an abnormality, such as a break, shortcircuit, etc., regarding the first linear solenoid valve SLB1 and the second linear solenoid valve SLB2, the abnormality determination only on a break or on shortcircuit is also allowable.

The above-described embodiment is a mere embodiment, and the invention can be carried out in various ways with modifications, improvements and the like made on the basis of the knowledge of those of ordinary skill in the art.

While the invention has been described with reference to exemplary embodiments thereof, it is to be understood that the invention is not limited to the exemplary embodiments or constructions. To the contrary, the invention is intended to cover various modifications and equivalent arrangements. In addition, while the various elements of the exemplary embodiments are shown in various combinations and configurations, which are exemplary, other combinations and configurations, including more, less or only a single element, are also within the spirit and scope of the invention.

What is claimed is:

1. A control device of an automatic transmission, comprising:
a plurality of friction engagement devices;
a plurality of solenoids whose electrification amount supplied is controlled to adjust engagement force of the friction engagement devices, and which are switched between electrification and non-electrification so as to switch between speed change steps of the automatic transmission; and
an abnormality determiner that performs abnormality determination regarding the solenoids based on predetermined condition,
wherein the solenoids operate when supplied with an electrification amount that exceeds a predetermined value, and the abnormality determiner performs the abnormality determination by supplying a solenoid put in a non-electrified state, of the solenoids, with an electrification amount that is less than or equal to the predetermined value.

2. The control device of the automatic transmission according to claim 1, wherein each solenoid has a dead band where the solenoid does not operate when the electrification amount supplied is less than or equal to the predetermined value.

3. The control device of the automatic transmission according to claim 1, wherein the abnormality determiner performs the abnormality determination during a run on a speed change step that is achieved when the solenoids are put into a non-electrified state.

4. The control device of the automatic transmission according to claim 3, wherein at least one solenoid of the solenoids is switched in valve state to a position for completely engaging the friction engagement devices when put into the non-electrified state.

5. In an automatic transmission that switches between speed change steps by switching between electrification and non-electrification of a plurality of solenoids whose electrification amount supplied is controlled to adjust engagement force of a plurality of friction engagement devices, a control method of the automatic transmission which control method performs abnormality determination regarding the solenoids, comprising
operating the solenoids by supplying thereto an electrification amount that exceeds a predetermined value; and
performing the abnormality determination by supplying a solenoid put in a non-electrified state, of the solenoids, with an electrification amount that is less than or equal to the predetermined value.
